(19) United States
(12) Patent Application Publication
(10) Pub. No.: US 2004/0018790 A1
(43) Pub. Date: Jan. 29, 2004

(54) Method of seaming retroreflective sheeting and corresponding articles

(75) Inventors: Kanta Kumar, St. Paul, MN (US); Chester A. Bacon JR., Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/202,150

(22) Filed: Jul. 24, 2002

(51) Int. Cl. B32B 27/12; D04H 1/00; D04H 5/00; D04H 13/00

(52) U.S. Cl. 442/286; 442/394

(57) ABSTRACT

The invention relates to methods of seaming sheeting or films including retroreflective sheeting and the corresponding articles. The method comprises providing at least two pieces of polymeric sheeting or film such as retroreflective sheeting, each piece having a viewing surface and an opposing surface, overlapping the two pieces along an edge such that the viewing surface of the first piece is in contact with the opposing surface of the second piece and the exposed viewing surface is in contact with a removable protective top film at least at the overlap, and forming a seam at the overlap.

### FIELD OF THE INVENTION

The invention relates to methods of seaming sheeting or films including retroreflective sheeting and the corresponding articles.

### BACKGROUND OF THE INVENTION

Retroreflective conspicuity devices, such as trailer tarpaulins or a roll-up signs, have been developed to increase safety especially during periods of reduced visibility. Such articles typically employ flexible fabric materials bonded to a retroreflective layer. The flexible fabric materials are typically coated with a suitable polymeric material, such as highly plasticized polyvinyl chloride (PVC).

PCT Application WO 93/10985 published Jun. 10, 1993, discloses a tarpaulin comprising a fabric coated with a plastics material, preferably PVC, polyamide or polyprene, is provided with a decoration of a reflecting material by anchoring a reflecting sheeting to a piece of tarpaulin cloth, whose plastics coating is of the same type or is compatible with that of the tarpaulin by high frequency welding or heat application, and then applying the piece of tarpaulin cloth provided with reflecting sheet, optionally formed in the desired shape, to the tarpaulin by hot air fusion.

U.S. Pat. No. 5,962,108 relates to a process and article for a retroreflective polymeric coated flexible fabric material having a retroreflective layer and a polymeric compatibilizing layer welded to a polymeric coated outer surface of a flexible fabric material. The compatiblizing layer provides an intermediate layer between the retroreflective layer and the flexible fabric material creating suitable bond strength between dissimilar polymers.

WO 00/12301 describes a flexible outdoor sign comprising a flexible substrate layer and a flexible reflective layer, wherein the sign is of a grand formal dimension that is greater than 48 inches wide, and further being most applicable to outdoor billboards, truck curtains and other larger outdoor venues. Due to its flexible nature, this sign can be rolled up and transported easily, as it does not depend on heavy plywood backing to support it. Upon being delivered, the sign can be unrolled and winched around a billboard, for example. The sign is then anchored with trucking straps, or the like. This reference also relates to a flexible sign material made into grand format dimensions, as well as a method for making this material.

### SUMMARY OF THE INVENTION

The present inventor has found advantage in seaming retroreflective sheeting while the outermost viewing surface of the sheeting is in contact with a removable protective top film. The discovery is particularly advantageous for thermal welding methods such as radio frequency (RF) welding. The resulting article exhibits improved properties including increased smoothness and improved printability, particularly at the seam. Accordingly, the invention is advantageous when making large-sized retroreflective articles formed by seaming at least two pieces of retroreflective sheeting together. The seamed area is substantially free of voids in the printed indicia, increasing the legibility and visibility of such articles.

In one embodiment the method of seaming polymeric sheeting comprises providing at least two pieces of polymeric sheeting or film, each piece having a viewing surface and an opposing surface, overlapping the two pieces along an edge such that the viewing surface of the first piece is in contact with the opposing surface of the second piece and the exposed viewing surface is in contact with a removable protective top film at least at the overlap, contacting the opposing surfaces of the overlapped retroreflective sheeting with a polymeric layer, and forming a seam at the overlap such that the overlapped pieces are bonded to each other and to the polymeric layer.

In another embodiment, the method of seaming polymeric sheeting comprises providing at least two pieces of polymeric sheeting or film, each piece having a viewing surface and an opposing surface, overlapping the two pieces along an edge such that the viewing surface of the first piece is in contact with the opposing surface of the second piece and the exposed viewing surface is in contact with a removable protective top film at least at the overlap; and forming a seam at the overlap.

Also described is an article comprising at least two pieces of seamed polymeric sheeting or film comprising a removable protective top film on the viewing surface at least above the seam.

The removable protective top film may be provided in the form of a strip that only contacts the viewing surface at the overlap. Preferably, however, the viewing surface of the pieces of sheeting are preferably substantially covered with removable protective top film. For embodiments wherein the seamed sheeting is welded to another layer such as a polymeric coated backing, a weld pattern is preferably formed throughout the viewing surface of the article. The embodied methods may optionally further comprises removing the removable protective top film and optionally printing on the sheeting. For such embodiments, the removable protective top film is preferably removed near the time of printing (within about 48 hours). The invention is particularly useful for making a large-sized article wherein at least three pieces of sheeting are seamed or at least one dimension that is greater than 48 inches.

### BRIEF DESCRIPTION OF THE DRAWINGS

FIG. 1 is a sectional view of a preferred retroreflective article in accordance with the invention. The viewing surface of the article comprises two pieces of overlapping retroreflective sheeting 1 and 2 that have been bonded to each other forming a seam. Each piece of sheeting comprises cube-corner elements 3 bonded to an overlay film 4. At the overlap, an interface 6 is formed that is substantially free of removable protective top film. A removable protective top film 7 is present at the outermost viewing surface of the retroreflective layer 1 and 2, particularly at the location of the overlap. In the method of forming the article, the sheeting is preferably seamed with radio frequency antennae/electrode platens 8.

FIG. 2 is a sectional view of a retroreflective article in accordance with the invention. The overlapped retroreflective layers 1 and 2 are bonded to a polymeric layer 9 that has been optionally, yet preferably, bonded to a fabric backing 10.

FIG. 3 is a plan view of the retroreflective article of FIG. 2 depicting the seam 11 and optional weld pattern 12 that was formed as a result bonding the retroreflective layers 1 and 2 to the polymeric layer or polymeric coated fabric.

FIG. 4 is a sectional view of a retroreflective article in accordance with the invention having only a strip of removable protective top film on the viewing surface at the location of the seam.

### DETAILED DESCRIPTION OF THE PREFERRED EMBODIMENTS

The invention generally concerns the bonding of at least two pieces of polymeric sheeting or film materials such as retroreflective sheeting. The polymeric sheeting or film material preferably have sufficient strength such that the sheeting or film is free-standing. In the method of the invention, the at least two pieces of retroreflective sheeting are seamed while the outermost surface of at least the seam area is in contact with a removable protective top film. As used herein, “seamed” refers to a permanent bond formed at a junction between two pieces material. The efficacy of the bond strength can be measured using a tensile bond test and/or a T-peel test. A suitable test includes a tensile test based on ASTM D 882 with the changes noted in the examples herein. “Removable protective top film” refers to a coated paper or film layer that can easily be removed from the polymeric sheeting or film by hand without damaging the polymeric sheeting or film (e.g. retroreflective sheeting). The removable top film is not permanently bonded to the polymeric sheeting or film, nor is this removable top film typically present on the finished article during use.

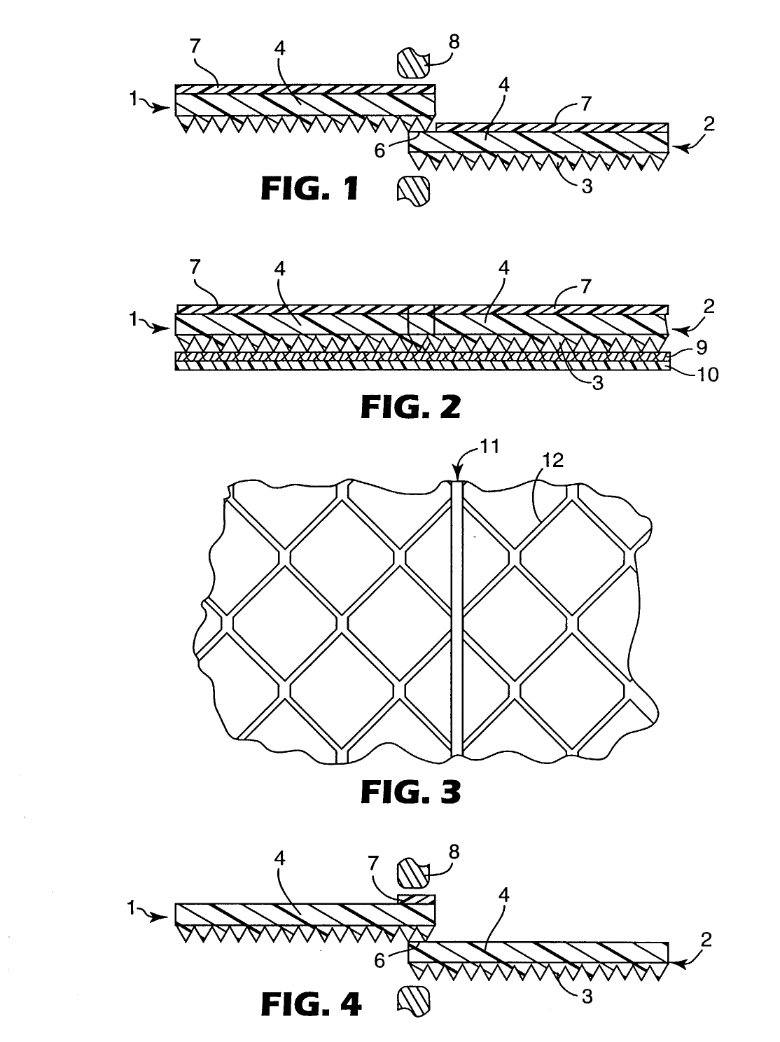

Polymeric sheeting and films are typically supplied in rolls having a specific width. For example, several types of retroreflective sheeting are commercially available in rolls having a width ranging from about 18″ to about 25″. Accordingly, if a retroreflective article is desired wherein the shortest dimension is greater than the standard width, one must seam two or more pieces of retroreflective sheeting together forming a single continuous sheet having a seam. For example, in order to create a 48″ by 48″ roll-up sign, one must seam together two pieces of 25″ width sheeting. In the case of truck tarpaulin wherein the smallest dimension typically ranges from about 55″ to about 100″, at least 2 to 4 pieces are seamed together. For even larger retroreflective articles, such as billboards and advertising displays, 5 or more pieces of retroreflective sheeting would be seamed together in order to obtain a 10′ by 48′ billboard. Although, the present invention is surmised advantageous for any type of seam between sheeting (e.g. retroreflective), particularly wherein the seam is subsequently imaged, the pieces of sheeting are typically seamed along an edge, as depicted by FIGS. 1, 2 and 4, by overlapping the two pieces such that the viewing surface of the first piece is in contact with the opposing surface of the second piece and the exposed viewing surface is in contact with a removable protective top film at least at the overlap. The interface between the two pieces of sheeting is typically substantially free of the removable protective top film at the overlap as the presence thereof typically interferes with the formation of a bond. In lieu of removing the protective top film entirely from the interface, as an alternative it is surmised to sufficiently perforate the protective top film at the interface such that a permanent bond may be formed between the pieces of sheeting through the protective top film.

The sheeting (e.g. retroreflective) may be concurrently or subsequently bonded to a polymeric layer, optionally provided on a backing such as a flexible fabric, during the seaming of the pieces. The polymeric layer may be provided as a preformed film or provided as a coating layer that has been applied to a second removable protective film or to a backing, such as a flexible fabric material. The coating may be water-based, solvent-based or 100% solids. Further, the coating may be crosslinked or cured on the removable protection film or backing prior to bonding with the sheeting (e.g. retroreflective layer).

For embodiments wherein such additional layers are provided, the method preferably includes forming a weld pattern with a thermal welding technique throughout the dimensions of the article wherein such weld pattern bonds the non-viewing surface of the sheeting to the polymeric layer. After seaming and optionally forming a weld pattern, while the outermost exposed surface of the sheeting is in contact with removable protective top film at least at the area of the seam, the resulting laminate (e.g. flexible retroreflective article) exhibits improved surface properties. In one regard, the viewing surface exhibits increased smoothness, particularly at the seam and weld pattern. In a second aspect, the viewing surface exhibits improved printability. The present inventor has found that the viewing surface exhibits very good ink adhesion without being cleaned with isopropyl alcohol (IPA) before screen printing, as was typically needed for sheeting based on plasticized PVC that was bonded in the same manner with the removable protective top film absent during the bonding step. Further, the screen printed ink adhered well at the locations of the seams and welds of the weld pattern. The seam(s) and weld(s) were substantially free of voids in the intended image.

The at least two pieces of sheeting are seamed, and optionally bonded to a polymeric layer (i.e. second polymeric layer of the same or different composition as the first polymeric sheeting or film), by any thermal welding technique (e.g. heated embossed roller), wherein the presence of a removable protective top film during the formation of the seal contributes the improved surface properties, previously described, and the removability of the protective top film is not impaired.

A preferred thermal welding technique includes radio frequency (RF) energy. The frequency of the radio frequency energy and the field strength are variable by an operator and chosen for suitability dependent upon the polymeric components within the polymeric sheeting or film (e.g. retroreflective sheeting), and polymeric layer or polymeric coated flexible fabric (i.e. if either or both are present). The choice depends on such factors as the individual polymeric dielectric loss factors, dielectric constants, melting temperatures, and layer thickness. The radio frequency energy is delivered through antennas mounted within appropriate platens that are pressed onto the appropriate surfaces of the retroreflective flexible fabric material applying an appropriate amount of pressure and an appropriate duration of radio frequency energy. Reference is made to the article “RF Welding of PVC and Other Thermoplastic Compounds” by J. Leighton, T. Brantley, and E. Szabo in ANTEC 1992, pps. 724-728 as well as to U.S. Pat. No. 5,962,108, incorporated herein by reference.

A removable protective top film is typically present on the entire viewing surface of the retroreflective sheeting as provided by the supplier. An exemplary retroreflective sheeting including a removable protective top film includes retroreflective material commercially available from 3M Company (“3M”), St. Paul, Minn. under the trade designation “Scotchlite Reflective Material 6260 White High Gloss Film” and “Scotchlite Reflective Material 6287 Fluorescent lime-yellow High Gloss Film”. Modifications of such retroreflective sheeting having different fluorescent colors, such as orange, are often preferred for safety uses. Alternatively, a removable protective top film may be applied to the surface of the seam or the entire viewing surface of the sheeting prior to bonding. In the embodiment depicted in FIG. 4, a strip of removable protective top film is only applied above the area to be seamed. In this embodiment, the remainder of the viewing surface of the sheeting (e.g. retroreflective) is substantially free of such removable protective top film. Although paper release liners may be suitable for some bonding methods, the removable protective top film is preferably a polymeric film such as polyester terephthalate (PET).

The two most common types of retroreflective sheeting suitable for use are microsphere-based sheeting and cube corner-based sheeting. Microsphere sheeting, sometimes referred to as “beaded sheeting,” is well known to the art and includes a multitude of microspheres typically at least partially embedded in a binder layer, and associated specular or diffuse reflecting materials (such as metallic vapor or sputter coatings, metal flakes, or pigment particles). Illustrative examples of microsphere-based sheeting are disclosed in U.S. Pat. Nos. 4,025,159 (McGrath); 4,983,436 (Bailey); 5,064,272 (Bailey); 5,066,098 (Kult); 5,069,964 (Tolliver); and 5,262,225 (Wilson).

The retroreflective layer preferably comprises a cube corner sheeting, sometimes referred to as prismatic, microprismatic, or triple mirror reflector sheeting, that comprises a multitude of cube corner elements to retroreflect incident light. Cube corner retroreflectors typically include a sheet having a generally planar front surface and an array of cube corner elements protruding from the back surface. Cube corner reflecting elements include generally trihedral structures that have three approximately mutually perpendicular lateral faces meeting in a single corner—a cube corner. In use, the retroreflector is arranged with the front surface disposed generally toward the anticipated location of intended observers and the light source. Light incident on the front surface enters the sheet and passes through the body of the sheet to be reflected by each of the three faces of the elements, so as to exit the front surface in a direction substantially toward the light source. In the case of total internal reflection, the air interface must remain free of dirt, water and adhesive and therefore is enclosed by a sealing film. The light rays are typically reflected at the lateral faces due to total internal reflection, or by reflective coatings, as previously described, on the back side of the lateral faces. Polymers for cube corner sheeting include poly(carbonate), poly(methylmethacrylate), poly(ethylene terephthalate), aliphatic polyurethanes, as well as ethylene copolymers and ionomers thereof.

The cube corner sheeting is preferably prepared by casting directly onto a film, such as described in U.S. Pat. No. 5,691,846 (Benson), incorporated herein by reference. Preferred polymers for radiation-cured cube corners include crosslinked acrylates such as multifunctional acrylates or epoxies and acrylated urethanes blended with mono- and multifunctional monomers. The cube corners are preferably cast on to plasticized polyvinyl chloride (PVC) film (i.e. overlay film) for more flexible cast cube corner sheeting.

In embodiments wherein the sheeting is likely to be exposed to moisture, the cube corner retroreflective elements are preferably encapsulated with a seal film. In instances wherein cube corner sheeting is employed as the retroreflective layer, a backing layer may be present for the purpose of opacifying the laminate or article, improving the scratch and gouge resistance thereof, and/or eliminating the blocking tendencies of the seal film. Illustrative examples of cube corner-based retroreflective sheeting are disclosed in U.S. Pat. Nos. 5,138,488 (Szczech); 5,387,458 (Pavelka); 5,450,235 (Smith); 5,605,761 (Burns); 5,614,286 (Bacon Jr.) and 5,691,846 (Benson, Jr.).

The polymer(s) for the retroreflective layer/sheeting are typically chosen based on one or more properties including thermal stability, environmental stability, clarity, excellent release from the tooling or mold, and capability of receiving a reflective coating. The retroreflective layer, (i.e. including the overlay film and/or binder), are generally comprised of polymeric materials that transmit at least 70% of the intensity of the light incident upon the polymer at a given wavelength. More preferably, the polymers that are used in the retroreflective layer of the invention have a light transmissibility of greater than 80%, and more preferably greater than 90%.

Colorants, UV absorbers, light stabilizers, free radical scavengers or antioxidants, processing aids such as antiblocking agents, releasing agents, lubricants, and other additives may be added to the retroreflective layer. Particularly in the case of conspicuity articles, the retroreflective layer preferably comprises a daylight fluorescent dye (i.e. one that emits visible light upon exposure to light of a visible wavelength) dissolved in the polymeric matrix of the cube corner elements and/or overlay film. Alternatively or in addition thereto, the article may further comprise a color layer comprising a daylight fluorescent dye in a polymeric matrix. The polymeric matrix is preferably substantially transparent to visible light, particularly to light of the wavelengths emitted by the dye and light of the wavelengths that cause the dye to fluoresce. The particular daylight fluorescent dye is typically selected based on the desired color, solubility with the polymeric matrix and stability in the polymeric matrix. Typically, the color layer contains between about 0.01 and about 3.0, and preferably between about 0.05 and about 1.0, weight percent of dye. Color layers that contain lower amounts of dye may not exhibit the degree of bright fluorescence which is desired. Color layers which contain high levels of fluorescent dye may exhibit self-quenching phenomena. Preferred fluorescent dyes for polyvinyl chloride polymeric matrixes are described, for example, in U.S. Pat. No. 6,406,798, incorporated herein by reference.

For embodiments wherein the seamed retroreflective sheeting layers are bonded to a polymeric layer such as a backing film or polymeric coated fabric or scrim it is preferred that the retroreflective layer (i.e. overlay film or outermost binder layer) and polymeric layer are comprised of substantially the same material or made of materials that are compatible with each other such that a permanent bond can be formed at the seam and between the non-viewing surface and the polymeric layer with the chosen bonding technique. In a preferred embodiment, a retroreflective layer comprising a polyvinyl chloride overlay film is bonded (e.g. concurrently) to a polyvinyl chloride coated flexible fabric. Alternatively, however, in the case of dissimilar materials, a compatibilizing layer may be provided, as described for example in U.S. Pat. No. 5,962,108 incorporated herein by reference.

A preferred polymeric layer further comprising a backing is a polymeric coated flexible fabric material. Suitable base fabrics are weaves or scrims from nylon, polyester, and cotton. A PVC polymeric coating that has been plasticized with monomeric plasticizers is preferred primarily due to its relatively low cost and flexibility. Generally, the PVC polymer is coated on at least the outer surface of the flexible fabric base and may contain additional chemicals for coloring and stabilization of the PVC for improved durability, weatherability, and wearability. Often, an additional very thin coating of acrylic will be applied over a surface coated with PVC to enhance the hardness of the PVC surface without significantly altering the physical and chemical properties of the PVC coating. The PVC provides good flexibility, resistance to abrasion, stability to ultraviolet rays, and performance in cold temperatures. However, PVC is also highly plasticized with monomeric plasticizers in order to attain good flexibility. Typically the PVC will contain up to 30 to 40% by weight of monomeric plasticizers.

The present invention provides retroreflective materials (e.g. retroreflective flexible fabrics) having a coefficient of retroreflectivity of at least about 30 candelas per lux per square meter, typically of at least 50 candelas per lux per square meter, preferably of at least 100 candelas per lux per square meter and more preferably of at least about 200 candelas per lux per square meter at 0.2° observation angle and −4° entrance angle for the average of 0° and 90° orientation angles. Preferably the inventive articles provide a coefficient of retroreflectivity greater than 400 candelas per lux per square meter and even more preferably providing greater than 600 candelas per lux per square meter.

The retroreflective sheeting is constructed so as to maintain an excellent degree of flexibility without any cracking or mechanical failure. For example, the sheeting may be wrapped around curved or otherwise non-planar surfaces without damage. In one test, this flexibility was measured by wrapping the retroreflective sheeting around a cylindrical mandrel having a 3.2 mm (0.125 inch) diameter. The test was performed at 0° C. with good results, i.e. no visible cracking.

The seamed retroreflective materials are useful for numerous applications, for example, but not limited to, use by humans in articles of clothing for safety or fashion or accessories, as well as articles for use on signs and machinery such as road signs, roll up signs, flags, banners, cone wrap sheeting, post wrap sheeting, barrel wrap sheeting, barricade sheeting, sign sheeting, vehicle marking sheeting, segmented vehicle marking sheeting, pavement marking tapes and sheeting; retroreflective tapes and decals, sew-on retroreflective articles, flexible vehicle covers, tarpaulins, warning tapes, and conspicuity markings. The dimensions of the articles are typically such that the shortest dimension is greater than the shortest dimension of the commercially available sheeting. For large-sized retroreflective article, the shortest dimension is typically greater than 48″ and more typically greater than 60″. However, the present invention may also be employed to seam smaller pieces of sheeting as well, particularly to reduce waste sheeting that is smaller is size than desired. The article may comprise entirely of the seamed retroreflective sheeting described herein or may comprise a portion of such. The seamed retroreflective sheeting is also useful for decorative and structural webbing for displaying graphic designs and logos as well as providing patches for attachment to such articles.

The articles (e.g. retroreflective) may include a pressure sensitive adhesive on the non-viewing surface of the article in order to secure the article to a substrate or surface, such as a roadway, sign surface or billboard backing.

Objects and advantages of this invention are further illustrated by the following examples, but the particular materials and amounts thereof recited in these examples, as well as other conditions and details, should not be construed to unduly limit this invention.

### Preparation of the Laminate/Retroreflective Articles

### COMPARATIVE EXAMPLE A

A retroreflective sheeting was provided that had the same construction as retroreflective sheeting commercially available from 3M under the trade designation “Scotchlite Reflective Material 6260 White High Gloss Film” with the exception that the sheeting was colored fluorescent orange. The cube-corner sheeting was made by the process described in U.S. Pat. No. 5,691,846 having a polyvinyl chloride overlay film covered by a 2 mil (0.051 mm) polyester terephthalate removable protective top film. The protective top film was removed and the outside edges of two pieces of sheeting were overlapped by 3/16″ such that the viewing surface of the first piece contacted the opposing (i.e. non-viewing) surface of the second piece. The overlapped retroreflective sheeting were positioned on top (i.e. viewing surface of the sheeting facing up) of a single piece of PVC coated polyester knit fabric, commercially available from Herculite Products, Inc., York, Pa. under the trade designation “Architent”. The overlapped sheeting were fused together simultaneously with the sheeting being fused to the PVC coated surface of the coated fabric with radio frequency welding in a 1″×1″ grid pattern using 60KW welder forming a 48″×48″ flexible retroreflective article having a single seam at approximately at the middle of the article.

### EXAMPLE 1

Two pieces of retroreflective sheeting were simultaneously fused together and bonded to PVC in the same manner as Comparative Example I with the exception that the removable protective top film was left in contact with the overlay film during RF welding except for at the interface between the two pieces of sheeting at the area of the overlap. The polyester terephthalate protective top film did not bond to PVC overlay film and could be easily removed by peeling it off by hand.

Testing of Seam and Weld Strength

The bond strength of the seam and welds of the weld pattern were evaluated with a modified version of ASTM D882. The samples were cut into ¾″ (19.05 mm) wide strips perpendicular to RF weld. Before placing the samples in the jaw, the middle portion of the unbonded back fabric between the welds or seam was cut off leaving the seam and weld intact. The jaw separation was 2″ allowing a total of 2 welds (seam and weld or two welds) only. The jaw separation rate was 12″/min (305 mm/min). The force versus extension curves were recorded. The peak force from the average of 6 measurements is reported in force/in as follows:

| | |
|---|---|
| Comparative Example A (sample with 1 seam and 1 weld) | 12.8 lb/in |
| Comparative Example A (sample with 2 welds) | 11.2 lb/in |
| Example 1 (sample with 1 seam and 1 weld) | 13.4 lb/in |
| Example 1 (sample with 2 welds) | 13.5 lb/in |

The results demonstrate that the bond strength was not compromised by the presence of the removable top film during the formation of the seam.

Printing the Laminates

Four samples of sheeting as described per Comparative Example A and Example 1 were screen printed using ink commercially available from 3M under the trade designation “Scotchlite 1805” using a 60 mesh screen.

The samples were inspected immediately after printing. In the case of Comparative Example A, several of the seams and weld pattern areas were void of ink at the locations of the seam/weld. However, Example 1 did not exhibit such voids in the indicia.

One sample of each type were stored at ambient conditions (25° C.) for 5 days and one sample of each type were heat aged by placing the sheeting in an air-circulating oven at 150° F. for 5 days. In the case of the sample prepared according to Example 1, the polyester terephthalate removable protective top film was left intact during heat aging and removed just prior to the screen printing. All four samples were not cleaned by wiping with isopropyl alcohol (IPA) before screen printing. The printed samples were air dried for 24 hrs and ink adhesion was tested by scoring the ink coated surface in a cross hatch pattern with a sharp razor blade, the parallel and perpendicular scores being spaced apart an intervals of about ⅛″ (3 mm). A 1″ by 4″ piece (2.5 cm by 10 cm) of tape commercially available from 3M under the trade designation “3M Scotch 898” or “3M Scotch Brand Tape 610” was repeatedly contacted to the scored ink coated surface, quickly adhering a 1 square inch (2.54 cm²) portion followed by rapid removal at the rate of about one repetition every 5 to 10 seconds. The ink adhesion was observed and rated according to the following criteria:

0—no removal of ink

1—10% removal

3—30% removal

5—50% removal

7—70% removal

10—100% removal of ink indicating very poor adhesion of ink to the vinyl.

TABLE 1
Ink Adhesion Results

| | Adhesion | | Adhesion | |
|---|---|---|---|---|
| | Rating Ambient Storage | | Rating after Heat Aging | |
| Example # | 610 tape | 898 tape | 610 tape | 898 tape |
| Comparative A | 1 | 3 | 10 | 10 |
| Example 1 | 0 | 0 | 0 | 0 |
| Comparative A | 10 | 10 | 10 | 10 |
| Example 1 | 0 | 0 | 0 | 0 |

As shown in Table 1, the sheeting wherein the seam and weld pattern were formed while the removable protective film was in contact with the retroreflective sheeting exhibits very good adhesion to ink even after heat aging while Comparative Example A sheeting exhibited poor ink adhesion particularly after heat aging.

What is claimed:

1. A method of seaming polymeric sheeting comprising:
providing at least two pieces of polymeric sheeting or film, each piece having a viewing surface and an opposing surface;
overlapping the two pieces along an edge such that the viewing surface of the first piece is in contact with the opposing surface of the second piece and the exposed viewing surface is in contact with a removable protective top film at least at the overlap;
contacting the opposing surfaces of the overlapped retroreflective sheeting with a polymeric layer; and
forming a seam at the overlap such that the overlapped pieces are bonded to each other along the edge and to the polymeric layer.

2. The method of claim 1 wherein the pieces of polymeric sheeting are retroreflective sheeting.

3. The method of claim 1 wherein the viewing surface of the pieces of sheeting is substantially covered with removable protective top film.

4. The method of claim 1 wherein a weld pattern is formed throughout the viewing surface of the article.

5. The method of claim 1 wherein the polymeric layer is bonded to a backing.

6. The method of claim 5 wherein the backing comprises fabric.

7. The method of claim 1 further comprising removing the removable protective top film.

8. The method of claim 7 further comprising printing on the sheeting.

9. The method of claim 7 wherein the removable protective top film is removed about 48 hours prior to printing.

10. The method of claim 8 wherein at least a portion of the seam is printed.

11. The method of claim 2 wherein the retroreflective sheeting comprises a retroreflective layer and an overlay film on the viewing surface.

12. The method of claim 11 wherein the retroreflective layer comprises cube-corner retroreflective elements.

13. The method of claim 11 wherein the overlay comprises polyvinyl chloride.

14. The method of claim 2 wherein the retroreflective sheeting comprises glass microspheres.

15. The method of claim 1 wherein the seam is formed with a thermal welding technique.

16. The method of claim 1 wherein the seam is formed with a radio frequency bonding technique.

17. The method of claim 1 wherein the removable protective top film comprises polyester.

18. The method of claim 1 wherein at least three pieces of sheeting or film are seamed.

19. The method of claim 1 wherein the seamed article has at least one dimension that is greater than 48 inches.

20. A method of seaming polymeric sheeting comprising:
providing at least two pieces of polymeric sheeting or film, each having a viewing surface and an opposing surface;
overlapping the two pieces along an edge such that the viewing surface of the first piece is in contact with the opposing surface of the second piece and the exposed viewing surface is in contact with a removable protective top film at least at the overlap; and
forming a seam at the overlap.

21. The method of claim 20 wherein the pieces of polymeric sheeting are retroreflective sheeting.

22. The method of claim 21 wherein the retroreflective sheeting comprises glass microspheres.

23. The method of claim 20 wherein the removable protective top film comprises a strip that only contacts the viewing surface at the overlap.

24. The method of claim 20 wherein the viewing surface of the pieces of sheeting are substantially covered with the removable protective top film.

25. The method of claim 20 wherein the seam is formed with a thermal welding technique.

26. The method of claim 20 wherein the seam is formed with a radio frequency bonding technique.

27. The method of claim 20 comprising removing the removable protective top film.

28. The method of claim 27 comprising printing on the sheeting.

29. The method of claim 27 wherein the removable protective top film is removed about 48 hours prior to printing.

30. The method of claim 28 wherein at least a portion of the seam is printed.

31. The method of claim 1 wherein at least three pieces of sheeting are seamed.

32. The method of claim 1 wherein the seamed article has at least one dimension that is greater than 48 inches.

33. A seamed article comprising:
at least two pieces of seamed polymeric sheeting or film comprising a removable protective top film on the viewing surface at least above the seam.

34. The article of claim 33 wherein the pieces of polymeric sheeting are retroreflective sheeting.

35. The article of 33 wherein the viewing surface of the pieces is substantially covered with removable protective top film.

36. The article of claim 33 wherein the seamed sheeting or film is bonded to a polymeric layer.

37. The article of claim 36 wherein the polymeric layer is further bonded to a backing.

38. The article of claim 37 wherein the backing comprises fabric.

39. The article of claim 33 wherein the removable protective top film comprises a strip that only contacts the viewing surface at the overlap.

40. The article of claim 34 wherein the retroreflective sheeting comprises glass microspheres.

41. The article of claim 33 wherein the article comprises at least three seams.

42. The article of claim 33 wherein the seamed retroreflective article has at least one dimension that is greater than 48 inches.
